(19) United States
(12) Patent Application Publication
(10) Pub. No.: US 2023/0255400 A1
(43) Pub. Date: Aug. 17, 2023

(54) Culinary Article With An Anti-Slip Outer Coating

(71) Applicant: SEB S.A., Ecully (FR)

(72) Inventor: Marie Le Bonnec, Ecully Cedex (FR)

(73) Assignee: SEB S.A., Ecully (FR)

(21) Appl. No.: 18/010,627

(22) PCT Filed: Jun. 23, 2021
(86) PCT No.: PCT/FR2021/051151

§ 371 Date: Dec. 15, 2022

(30) Foreign Application Priority Data
Jun. 25, 2020 (FR) FR2006682

(51) Int. Cl. A47J 36/02; B05D 5/08; B05D 7/00

(52) U.S. Cl. CPC A47J 36/025; B05D 5/083; B05D 7/50

(57) ABSTRACT

The present invention relates to a culinary article (1) comprising a support (2) having a bottom wall (21) and a side wall (31) rising around the bottom wall (21), the bottom wall (21) having an inner face (211) for receiving food and an outer face (212) intended to be disposed close to a heat source, and the side wall (31) having an inner face (311) and an outer face (312) characterised in that the outer faces (212) and (312) are covered with at least one continuous primer layer comprising at least one fluorocarbon polymer, the coating of the outer face (212) comprises, arranged between or in its layers, at least one decoration representing at least 20% of the surface of the outer face (212), which decoration comprises at least one fluorocarbon polymer, at least one polymer resin and between 5 and 25% by weight of mineral fillers and/or polymer fillers, in the form of particles of size d50 less than 25 μm. The invention also relates to a method for making such an article.

### TECHNICAL FIELD

The present invention relates to a culinary article having, on its outer face, a coating with improved anti-slip properties. The present invention also relates to the method of manufacturing such an article.

### PRIOR ART

With the development of glass, induction and glass-ceramic hobs, having a smooth and slippery surface, safety issues arise. The major problem comes from the slippage of culinary articles disposed on the burners, outside the hob, with the risk for the user of spilling the contents of the culinary article, injuring themselves or even burning themselves.

In addition, the outer coatings of the culinary articles are mainly composed of PTFE, and have the disadvantage of promoting sliding on the hobs, increasing the risk of accidents. The term promoting sliding denotes the ability conferred on the culinary article not to remain in position on the heating hearth. This property is related to the static and dynamic slip coefficients of the layer in contact with said hearth, therefore with the hobs. For safety reasons this sensitivity to sliding must be minimized.

Depending on the application method of the outer coating, techniques have been implemented by culinary article manufacturers to limit this phenomenon.

In screen printing, a metal strip is left uncoated, on the bottom of the article at the span. This uncoated aluminum portion allows to limit the slippage but the efficiency is very dependent on the concavity of the part. In addition, this metal strip tends to stain the glass-ceramic hobs.

During application by roller or spray, an outer PTFE and alumina based decoration is applied under the last 2 layers of roller finish. This layer has an anti-slip effect but has the disadvantage of scratching the hobs.

Other materials, such as silicone, are also used to provide anti-slip property. Unfortunately, these materials do not withstand the temperatures of use of culinary articles, for example for continuous cooking above 200° C.

There is therefore a need to offer culinary articles limiting the sliding phenomenon, in particular when they are disposed on smooth surfaces, such as hobs, in order to avoid domestic accidents, while avoiding scratches and staining of the support on which said articles are placed.

### DESCRIPTION OF THE INVENTION

To overcome the disadvantages presented above, the Applicant has developed a culinary article covered on its outer face with an anti-slip coating, in order to limit the sliding of said articles on the hobs, while reducing or even eliminating the scratches and stains on the support on which the article is placed. The Applicant has also developed a method of manufacturing said culinary article.

A first object of the invention relates to a culinary article 1 comprising a support 2 having a bottom wall 21 and a side wall 31 rising around the bottom wall 21, said bottom wall 21 having an inner face 211 intended to receive food and an outer face 212 intended to be disposed close to a heat source and said side wall 31 having an inner face 311 and an outer face 312, characterized in that:
the outer faces 212 and 312 are covered with at least one continuous primer layer comprising at least one fluorocarbon polymer;
the coating of the outer face 212 comprises, arranged between or in its layers, at least one decoration representing at least 20% of the surface of the outer face 212, which decoration comprises:
   at least one fluorocarbon polymer;
   at least one polymer resin;
   between 5 and 25% by weight of mineral fillers and/or polymer fillers, in the form of particles of d50 size less than 25 μm.

Another object of the invention relates to a method of manufacturing a culinary article according to the invention, comprising a support 2 having a bottom wall 21 and a side wall 31 rising around the bottom wall 21, said bottom wall 21 having an inner face 211 intended to receive food and an outer face 212 intended to be disposed close to a heat source and said side wall 31 having an inner face 311 and an outer face 312, said method comprising the following steps:
Providing a support 2;
Applying of at least one primer layer comprising at least one fluorocarbon polymer, on the outer faces 212 and 312 of the support 2;
Applying on at least 20% of the surface of the outer face 212 of at least one decoration comprising at least one fluorocarbon polymer, at least one polymer resin and 5 to 25% by weight of mineral fillers and/or polymer fillers, in the form of particles of d50 size less than 25 μm;
Curing said culinary article in the oven at a temperature comprised between 400 and 450° C., for 1 to 15 min.

### Definitions

Within the meaning of the present invention, the term “layer” should be understood to mean a continuous or discontinuous layer. A continuous layer (or also called monolithic layer) is a single whole forming a total solid completely covering the surface on which it is placed. A discontinuous layer (or non-monolithic layer) can comprise several parts, thus not being a single whole.

The terms “primer layer”, “bonding layer” or “bonding primer” are understood to mean all the layers from the first layer applied directly to the support, possibly mechanically prepared or treated with a sublayer (it is preferable that this layer adheres well to the support and brings all its mechanical properties to the coating: hardness, scratch resistance) to the last layer before the first decoration layer.

The terms “intermediate layer” are understood to mean any layer between the primer layers and the finish layers.

Within the meaning of the present invention, the terms “decoration” or “decoration layer” are understood to mean one or more continuous or discontinuous layers comprising mineral fillers and/or polymers fillers. A decoration is distinctly visible to the user with the naked eye and at a standard distance of use of the household article, due to the presence of pigment(s) and/or the presence of filler(s) creating a relief, a roughness, visible with the naked eye.

The terms “finish layer” or “finish” are understood to mean a continuous and transparent surface layer, this layer leaving a perfect visibility of the underlying layers while protecting them from mechanical aggression and conferring to the coating its non-stick properties. Finish layers are the last layers applied.

Within the meaning of the present invention, “culinary article” should be understood to mean an object intended for cooking. For this purpose, it is intended to receive a heat treatment.

Within the meaning of the present invention, “object intended to receive a heat treatment”, should be understood to mean an object which will be heated by an external heating system, such as frying pans, saucepans, sauté pans, woks, pancake pans, pots, cooking pots, pressure cookers, braising pans, stewpans, barbecue grills, pastry molds, fondue pots and which is able to transmit the calorific energy provided by this external heating system to a material or food in contact with said object.

The term “particles” is understood to mean small-sized elements of random shape, characterized in particular by their d50.

“d50” is understood to mean, within the meaning of the present invention, the dimension such that 50% by volume of the population consists of particles of size less than said dimension (median of the particle distribution). The term “size” is understood to mean the equivalent diameter, that is to say the diameter that the theoretical sphere would have, behaving in the same way as the particle in question.

### BRIEF DESCRIPTION OF FIGURES

FIG. 1 represents a schematic view of a culinary article according to the invention.

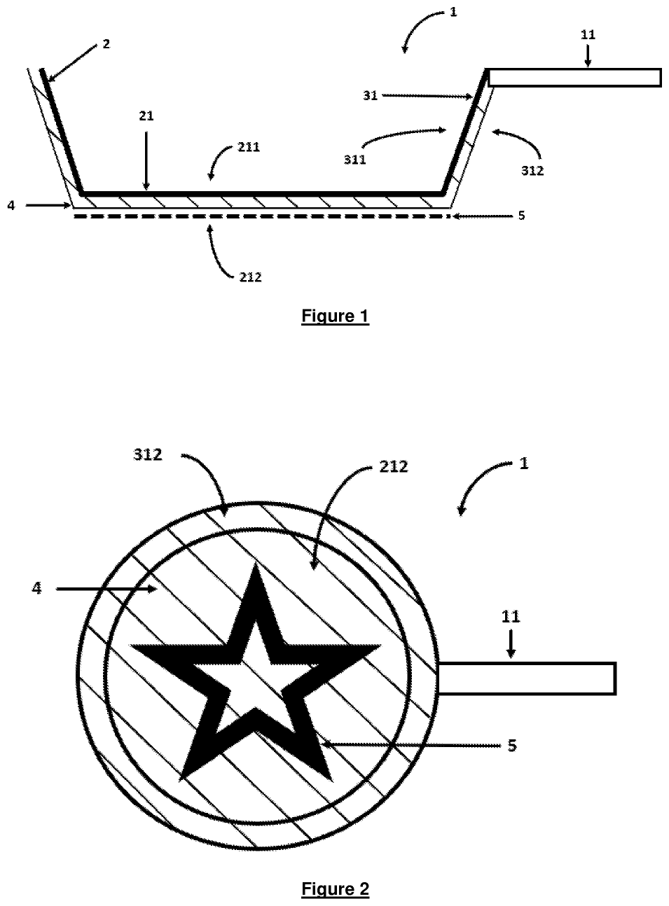

This figure represents in particular, as an example of a culinary article, a frying pan 1 with a gripping handle 11, which comprises a support 2 having a bottom wall 21 and a side wall 31 rising around the bottom wall 21, said bottom wall 21 having an inner face 211 intended to receive food and an outer face 212 intended to be disposed close to a heat source and said side wall 31 having an inner face 311 and an outer face 312.

The outer faces 212 and 312 are covered with at least one continuous primer layer 4 comprising at least one fluorocarbon polymer and the coating of the outer face 212 comprises, arranged between or in its layers, at least one decoration 5.

FIG. 2 represents a schematic view of the outer faces 212 and 312 of a culinary article according to the invention.

This figure represents, as an example of a culinary article, a frying pan 1 with a gripping handle 11, the outer faces 212 and 312 of which are covered with at least one primer layer 4 and the outer face 212 of which is coated with a decoration 5.

### DETAILED DESCRIPTION

A first object of the invention relates to a culinary article 1 comprising a support 2 having a bottom wall 21 and a side wall 31 rising around the bottom wall 21, said bottom wall 21 having an inner face 211 intended to receive food and an outer face 212 intended to be disposed close to a heat source and said side wall 31 having an inner face 311 and an outer face 312, characterized in that:
the outer faces 212 and 312 are covered with at least one continuous primer layer comprising at least one fluorocarbon polymer;
the coating of the outer face 212 comprises, arranged between or in its layers, at least one decoration representing at least 20% of the surface of the outer face 212, which decoration comprises:
   At least one fluorocarbon polymer;
   At least one polymer resin;
   between 5 and 25% by weight of mineral fillers and/or polymer fillers, in the form of particles of d50 size less than 25 μm.

Advantageously, the article is a culinary article of which one of the faces of the support constitutes a concave inner face intended to be in contact with food placed inside said article and the other face of the support of the article is a convex outer face intended to be in contact with a heat source.

The culinary article according to the invention is preferably selected from the group consisting of a saucepan, frying pan, stewpot, wok, sauté pan, pancake pan, cooking pot, and pressure cooker.

In the fields of application considered for the present invention, an article to be heated of the culinary article type is typically used in a range of temperatures comprised between 10° C. and 300° C.

The support comprises at least one element selected from a ceramic, a glass, a stellite, a metal alloy or a metal, in particular aluminum, copper, titanium or zirconium. The support is preferably metallic.

As metal supports that can be used in the context of the present invention for culinary articles, mention may in particular be made of supports having:
a single-layer structure made of anodized or non-anodized aluminum, or of polished, brushed, sandblasted or microblasted, chemically treated aluminum, or of cast aluminum, or of polished, brushed, sandblasted or microblasted steel, or of polished, brushed, sandblasted or microblasted stainless steel, or of cast steel, aluminum or iron, or of copper, optionally hammered or polished; or
a multilayer structure, in part or in whole, comprising from the outside towards the inside the following layers stainless steel/aluminum/stainless steel or else stainless steel/aluminum/copper/aluminum/stainless steel, or else a cap of cast aluminum, of aluminum or of aluminum alloys lined with a stainless steel outer bottom.

For a better adhesion of the coating, the surface of the support can be treated so as to increase its specific surface, for example by sandblasting.

The outer faces 212 and 312 of the bottom wall 21 of the culinary article are covered with at least one primer layer. In the case where the application of the primer layer is carried out on a preformed culinary article, the outer faces 212 and 312 of the bottom wall 21 are preferably covered with a single primer layer. In the case where the application of the primer layer is carried out on a non-preformed culinary article, in flat form, the outer faces 212 and 312 of the bottom wall 21 are preferably covered with two primer layers.

Advantageously, the thickness of each primer layer is less than 20 μm, preferably less than or equal to 15 μm.

Preferably, the thickness of the first primer layer is comprised between 5 and 15 μm, particularly preferably it is 10 μm.

Preferably, the thickness of the second primer layer is comprised between 10 and 20 μm, particularly preferably it is 15 μm.

In the case where there are several layers of primers, at least one of them is continuous. If there is only one primer layer, this one is continuous.

The fluorocarbon polymer can be selected from the group comprising polytetrafluoroethylene (PTFE), modified PTFE, copolymers of tetrafluoroethylene and perfluoropropylvinylether (PFA), copolymers of tetrafluoroethylene and hexafluoropropene (FEP), polyvinylidene fluoride (PVDF), copolymers of tetrafluoroethylene and polymethylvinylether (MVA), terpolymers of tetrafluoroethylene, polymethylvinylether and fluoroalkylvinylether (TFE/PMVE/FAVE), ethylene tetrafluoroethylene (ETFE), and mixtures thereof.

Advantageously, the fluorocarbon polymer can be selected from polytetrafluoroethylene (PTFE), or a mixture of PTFE and PFA (PTFE/PFA), or a mixture of PTFE and FEP (PTFE/FEP), or a mixture of PTFE, PFA and FEP (PTFE/PFA/FEP).

Particularly preferably, the fluorocarbon polymer is PTFE.

Advantageously, the proportion of fluorocarbon polymer(s) in each primer layer is comprised between 30% and 80%, preferably between 40% and 70% by dry weight relative to the total weight of said primer layer.

The primer layer(s) may comprise a bonding resin, in particular when the support has undergone mechanical treatment.

Preferably, the bonding resin(s) is (are) selected from the group consisting of polyamide imides (PAI), polyether imides (PEI), polyamides (PA), polyimides (PI), polyetherketones (PEK), polyetheretherketones (PEEK), polyaryletherketones (PAEK), polyethersulphones (PES), and polyphenylene sulfide (PPS), polybenzimidazoles (PBI), tannins.

The decoration represents at least 20% of the surface of the outer face 212 of the bottom wall 21, preferably the decoration represents at least 30%, even more preferably at least 30%.

Advantageously, the decoration represents less than 50% of the surface of the outer face 212 of the bottom wall 21, even more advantageously the decoration represents less than 40%.

The decoration comprises at least one fluorocarbon polymer selected from the group comprising polytetrafluoroethylene (PTFE), modified PTFE, copolymers of tetrafluoroethylene and perfluoropropylvinylether (PFA), copolymers of tetrafluoroethylene and hexafluoropropene (FEP), polyvinylidene fluoride (PVDF), copolymers of tetrafluoroethylene and polymethylvinylether (MVA), terpolymers of tetrafluoroethylene, polymethylvinylether and fluoroalkylvinylether (TFE/PMVE/FAVE), ethylene tetrafluoroethylene (ETFE), and mixtures thereof.

Advantageously, the fluorocarbon polymer of the decoration layer can be selected from polytetrafluoroethylene (PTFE), or a mixture of PTFE and PFA (PTFE/PFA), or a mixture of PTFE and FEP (PTFE/FEP), or a mixture of PTFE, PFA and FEP (PTFE/PFA/FEP).

Particularly preferably, the fluorocarbon polymer of the decoration layer is PTFE.

Advantageously, the proportion of fluorocarbon polymer(s) in the decoration layer is comprised between 30% and 80%, preferably between 40% and 70% and even more preferably between 30% and 60% by dry weight relative to the total weight of said decoration layer.

The decoration comprises at least one polymer resin selected from polyamide imides (PAI), polyether imides (PEI), polyamides (PI), polyetherketones (PEK), polyetheretherketones (PEEK), polyethersulphides (PES), polyphenylene sulphides (PPS), and mixtures thereof. Preferably, the polymer resin is selected from polyamide imides (PAI).

Preferably, the proportion of polymer resin(s) in the decoration layer is comprised between 0.5% and 3%, preferably between 1% and 1.5%, by dry weight relative to the total weight of said decoration layer.

Advantageously, the decoration comprises a ratio between the polymer resin and the fluorocarbon polymer comprised between 1.5 and 5, preferably 2.

Advantageously, the thickness of each decoration layer is less than 20 μm, preferably less than or equal to 15 μm, even more preferably less than or equal to 10 μm.

According to one embodiment, the decoration comprises mineral fillers selected from glass, stainless steel, alumina, boron nitride, talc, kaolin, or mixtures thereof.

According to another embodiment, the decoration comprises polymer fillers selected from polyaryletherketones, polyimides, polyphenylene sulphides and mixtures thereof.

The decoration may comprise a mixture of mineral fillers and polymer fillers.

The decoration comprises between 5 and 25% by weight, preferably between 10 and 20% by weight of mineral fillers and/or polymer fillers.

The mineral fillers and/or the polymer fillers are in the form of particles of d50 size less than 25 μm, preferably of d50 size less than 20 μm.

Preferably, the mineral fillers and/or the polymer fillers are in the form of particles of d50 size greater than 5 μm, preferably of d50 size greater than 10 μm.

Advantageously, the mineral fillers and/or the polymer fillers are of spherical shape.

The size, and therefore the d50 size, as well as the concentration of the fillers in the decoration layer can be evaluated by carrying out an electron microscope observation.

Preferably, the mineral fillers and the polymer fillers have a hardness on the Mohs scale less than or equal to 5.5. The Mohs scale for measuring the hardness of minerals is a nominal scale. The measurement of hardness on the Mohs scale is therefore based on the ability of a mineral to scratch a second mineral. Minerals with a hardness on the Mohs scale less than or equal to 5.5 (value corresponding to the hardness on the Mohs scale of window glass), can therefore be scratched by any mineral with a hardness on the Mohs scale greater than 5.5, such as orthoclase (hardness on the Mohs scale of 6).

Advantageously, the decoration can comprise one or more pigments, such as for example titanium dioxide, iron II oxide (FeO), iron Ill oxide (Fe₂O₃), carbon black, pyralene red, metallic glitters, mixed oxides of cobalt and manganese, blue pigments based on mica and titanium oxide and mixtures thereof.

Preferably, the decoration can comprise additives such as dispersing agents, spreading agents, antifoams, thickening agents.

The decoration can be positioned between two layers of primers or on the last primer layer.

Preferably, the decoration layer is discontinuous.

Advantageously, the decoration layer is rough, having asperities due to the presence of mineral fillers and/or polymer fillers. Advantageously, the decoration layer is visible with the naked eye.

Preferably, the last decoration layer is in contact with the heat source.

According to one embodiment, one or more finish layers are applied to the last intermediate layer or to the last primer layer. Preferably, the finish layer(s) comprise(s) one or more fluorocarbon polymer(s).

Advantageously, the finish layer(s) comprise(s) one or more thermostable resin(s).

Preferably, the finish layer(s) applied to the bottom of the culinary article are transparent.

Preferably, the finish layer(s) are continuous.

Another object of the invention relates to a method of manufacturing a culinary article comprising a support (2) having a bottom wall (21) and a side wall (31) rising around the bottom wall (21), said bottom wall (21) having an inner face (211) intended to receive food and an outer face (212) intended to be disposed close to a heat source and said side wall (31) having an inner face (311) and an outer face (312), said method comprising the following steps:
Providing a support (2);
Applying of at least one primer layer comprising at least one fluorocarbon polymer, on the outer faces (212) and (312) of the support (2);
Applying on at least 20% of the surface of the outer face (212) of at least one decoration comprising at least one fluorocarbon polymer, at least one polymer resin and 5 to 25% by weight of mineral fillers and/or polymer fillers, in the form of particles of d50 size less than 25 μm;
Curing said culinary article in the oven at a temperature comprised between 400 and 450° C., for 1 to 15 min.

Preferably, the support can undergo a surface treatment in order to improve the adhesion of the layer(s) of primer(s), such as a chemical treatment (pickling) or a mechanical treatment, for example by sandblasting or by brushing. Advantageously, the surface treatment can be followed by a degreasing step and/or dusting step.

The support can also undergo a microblasting step of the outer face 212 of the bottom wall 21.

The application of the primer layer(s) can be carried out by any method well known to the skilled person skilled, such as by spray, by roller, by screen printing, by curtain or by pad printing.

When the application of a primer layer is carried out by screen printing or by roller, a drying step is carried out.

Optionally, this drying step can also be carried out after the application of a primer layer by spraying.

The drying step allows to limit, or even to eliminate, the generation of defects, such as bubbles or cracks, in the coating during the curing step.

When the application of a primer layer is carried out by screen printing, a cooling step is carried out after the drying step.

Optionally, this cooling step can also be carried out after the drying step of the primer layer when the application is done by roller or by spraying.

Advantageously, the cooling step allows to avoid a too quickly drying of the new layer and a powdering phenomenon (the dried liquid product is in the form of a powder).

The application of the decoration layer(s) can be carried out by any method well known to the skilled person such as by spray, by roller, by screen printing, by curtain or by pad printing.

When the application of a decoration layer is carried out by screen printing or by roller, a drying step is carried out.

Optionally, this drying step can also be carried out after the application of a decoration layer by spraying.

The drying step allows to limit, or even to eliminate, the generation of defects, such as bubbles or cracks, in the coating during the curing step.

When the application of a decoration layer is carried out by screen printing, a cooling step is carried out after the drying step.

Optionally, this cooling step can also be carried out after the drying step of the decoration layer when the application is done by roller or by spraying.

Advantageously, the cooling step allows to avoid a too quickly drying of the new layer and a powdering phenomenon (the dried liquid product is in the form of a powder).

The decoration can be between two layers of primers, on the last primer layer.

The application of the finish layer(s) can be carried out by any method well known to the skilled person skilled such as by spray, by roller, by screen printing, by curtain or by pad printing.

The curing of the culinary article is carried out at a temperature comprised between 400 and 450° C., for 1 to 15 minutes, preferably between 410° C. and 420° C., at a temperature comprised between 2 and 6 minutes.

In the case of application by screen printing, a drying step is preferably carried out after the application at a temperature comprised between 45° C. and 70° C.

Depending on the shape of the culinary article that undergoes the manufacturing method, the culinary article may undergo stamping and/or finishing steps, such as trimming, welding and equipment attachment steps, in order to obtain a finished culinary article.

### Examples

1) Products
a) Brushed aluminum support
b) Elements of the primer layer:
   i) Fluoropolymer: PTFE in aqueous dispersion at 60% dry extract
   ii) Polymer resins: powders in aqueous emulsion
   iii) Black pigment: carbon black
c) —Elements of the decoration layer:
   i) PTFE in aqueous dispersion at 60% dry extract
   ii) Powder PAI in aqueous emulsion
   iii) Fillers:
      (1) Alumina particles with a d50=6.5 μm
      (2) Alumina particles with a d50=45 μm
      (3) PEEK particles with a d50=23 μm

2) Formulations
a) Primer layer (CP)
   i) Fluoropolymer: PTFE at 90% by weight of dry extract
   ii) Polymer resins: 2% by weight of dry extract
   iii) Black pigment: carbon black 5% by dry weight
   iv) Silica: 3% by dry weight
b) Decoration layer 1 (CD1 comprising alumina fillers)
   i) Fluorocarbon polymer: 51% PTFE by dry weight relative to the total weight of the decoration formulation
   ii) Polymer resin: 0.5% PAI by dry weight relative to the total weight of the decoration formulation
   iii) Fillers: 25% alumina (d50=6.5 μm) by dry weight relative to the total weight of the decoration formulation
   iv) Glitter
   v) Pigments
c) Decoration layer 2 (CD2 comprising polyaryletherketone fillers)
   i) Fluorocarbon polymer: 60% PTFE by dry weight relative to the total weight of the decoration formulation
   ii) Polymer resin: 0.5% PAI by dry weight relative to the total weight of the decoration formulation
   iii) Fillers: 25% PEEK (d50=23 μm) by dry weight relative to the total weight of the decoration formulation
d) Decoration layer 3 (CD3—Without fillers)
   i) Fluorocarbon polymer: PTFE at 60% by dry weight relative to the total weight of the decoration formulation
   ii) Polymer resin: 0.5% PAI by dry weight relative to the total weight of the decoration formulation
e) Decoration layer 4 (CD4—Without polymer resin)
   i) Fluorocarbon polymer: 60% PTFE by dry weight relative to the total weight of the decoration formulation
   ii) Fillers: 25% alumina (d50=6.5 μm) by dry weight relative to the total weight of the decoration formulation

Tests

Sliding Test of a Culinary Article on an Inclined Plane

Material
System for varying the inclination while measuring the angle from the horizontal
Glass plate or grid (material on which the culinary article is tested) having a flat surface
Soft weight
Electronic level

Carrying Out the Test

1) Preparation
a. The outer face of the culinary article is cleaned and wiped with a dry cloth
b. The support (grid or glass plate) is cleaned and wiped with a dry cloth
c. The support is placed on the system and the level is adjusted to be perfectly horizontal (angle at 0°)

2) Method for a Sequence
a. Place the article to be tested at the highest point.
b. Gradually raise the plate (2 to 3 seconds per degree).
c. Stop if a movement of the article is observed (if the article moves more than 1 cm, it is considered that there is slippage).
d. Check the slip angle with the level.
e. Repeat the operation, by slowing the climb when approaching the angle found earlier in order to confirm.
f. Note the angle found.

3) No-Load and Cold Test
a. Perform three sequences.

4) No-Load and Hot Test (Between 180° C. and 200° C.)
a. Perform three sequences

Scratch Test on a Glass-Ceramic Hob

The purpose of this test is to characterize the non-deterioration of glass-ceramic hobs. It allows to verify that a culinary article does not scratch the plate (test carried out cold). This test applies to glass-ceramic and induction compatible culinary articles. The equipment used comprises the culinary article, the clean, scratch-free glass-ceramic hob, and a 100 g weight.

The 100 g weight is placed in the center of the culinary article and the culinary article is disposed on the glass-ceramic hob. The culinary article is then moved horizontally on the plate from a point A to a point B, then from the point B to a point C (the points ABC forming a triangle), for 10 cycles.

The condition of the glass-ceramic hob is verified and the possible presence of scratches is noted.

### Example 1 (According to the Invention)

The primer, decoration and finish compositions are prepared according to the formulations described above.
1) A brushed aluminum blank is coated by screen printing with a continuous primer layer over its entire outer face, with the primer composition CP previously prepared;
2) A discontinuous decoration layer is applied by screen printing in the center of the outer face of the blank on the primer layer, representing 30% of the final surface of the outer face of the bottom of the culinary article, with the decorative composition CD1 previously prepared;
3) Curing the blank in the oven covered with these superimposed layers at a temperature of 415° C. for 3 minutes.
4) Microblasting step on the outer face of the blank to reduce the roughness of the decoration layer;
5) Stamping.

### Example 2 (According to the Invention)

Example 2 is identical to example 1, except that the aluminum blank is replaced by a preformed culinary article with a sandblasted aluminum support and that the different layers have been applied by spray.

### Example 3 (According to the Invention)

Example 3 is identical to example 1, except that the decoration composition CD2 is used, comprising PEEK fillers and that there is no microblasting step.

### Example 4 (Comparative—without Fillers)

Example 4 is identical to example 1, except that the decoration composition CD3 is used.

### Example 5 (Comparative—without Polymer Resin)

Example 5 is identical to example 1, except that the decoration composition CD4 is used.

### Example 6 (Comparative—Decorative Surface <20%)

Example 6 is identical to example 1, except that the decoration composition CD1 is applied only to 15% of the surface of the outer face of the bottom wall.

### Example 7 (Comparative—Amount of Fillers <5%)

Example 7 is identical to Example 1, except that the decoration composition CD1 only comprises 4% by weight of alumina fillers.

### Example 8 (Comparative—Alumina Fillers with d50>25 μm)

Example 8 is identical to example 1, except that the decoration composition CD1 comprises 25% of alumina fillers having a d50=45 μm.

The culinary articles described above are tested for slippage and scratching on the hob, according to the protocols described above

Results

| | Measured angle of | |
|---|---|---|
| Examples | inclination | Scratches on the plate |
| 1 | 11° | Very fine marks which disappear after |
| | | cleaning |
| 2 | 13° | Very fine marks which do not disappear |
| | | after cleaning |
| 3 | 11° | Very fine marks which disappear after |
| | | cleaning |
| 4 | 4° | Non-visible scratches |
| 5 | 11° | Residual loads (staining) and deep |
| | | scratches |
| 6 | 5° | Very fine and cleanable scratches |
| 7 | 4° | Non-visible scratches |
| 8 | 16° | Deep scratches |

According to these results, it is observed that the culinary articles having a decoration layer without fillers (example 4) or with an amount of fillers less than 5% (example 7) or having a decoration surface less than 20% of the outer face of the bottom wall (example 6), have a very small angle of inclination compared to the angles obtained by the culinary articles according to the invention (examples 1 to 3).

Also, it is observed that the culinary articles having a decoration layer without polymer resin (example 5) or containing fillers having a d50>25 microns (example 8), have a significant angle of inclination but cause deep scratches on glass-ceramic hobs or even a staining of the plates (example 8), in comparison with the culinary articles according to the invention (examples 1 to 3).

1. A culinary article comprising a support having a bottom wall and a side wall rising around the bottom wall, said bottom wall having an inner face intended to receive food and an outer face intended to be disposed close to a heat source and said side wall having an inner face and an outer face, wherein:
the outer faces and are covered with at least one continuous primer layer comprising at least one fluorocarbon polymer;
the coating of the outer face comprises, arranged between or in its layers, at least one decoration representing at least 20% of the surface of the outer face, which decoration comprises:
At least one fluorocarbon polymer;
At least one polymer resin;
between 5 and 25% by weight of mineral fillers and/or polymer fillers, in the form of particles of d50 size less than 25 μm.

2. The culinary article according to claim 1, wherein the polymer resin is selected from polyamide imides (PAI).

3. The culinary article according to claim 1, wherein the proportion of polymer resin(s) in the decoration layer is comprised between 0.5% and 3% by dry weight relative to the total weight of said decoration layer.

4. The culinary article according to claim 1, wherein the fillers have a hardness on the Mohs scale less than or equal to 5.5.

5. The culinary article according to claim 1, wherein the mineral fillers are selected from glass, stainless steel, alumina, boron nitride, talc, kaolin, or mixtures thereof.

6. The culinary article according to claim 1, wherein the polymer fillers are selected from polyaryletherketones, polyimides, polyphenylene sulphides and mixtures thereof.

7. The culinary article according to claim 1, wherein the support comprises at least one element selected from a ceramic, a glass, a stellite, a metal alloy or a metal, in particular aluminum, copper, titanium or zirconium.

8. The culinary article according to claim 1, wherein the mineral fillers or the polymer fillers are of spherical shape.

9. The culinary article according to claim 1, wherein the mineral fillers and/or the polymer fillers have a d50 greater than 5 μm.

10. The culinary article according to claim 1, wherein the decoration comprises between 10 and 20% of mineral fillers and/or polymer fillers.

11. A method of manufacturing a culinary article comprising a support having a bottom wall and a side wall rising around the bottom wall, said bottom wall having an inner face intended to receive food and an outer face intended to be disposed close to a heat source and said side wall having an inner face and an outer face, said method comprising the following steps:
Providing a support;
Applying of at least one primer layer comprising at least one fluorocarbon polymer, on the outer faces and of the support;
Applying on at least 20% of the surface of the outer face of at least one decoration comprising at least one fluorocarbon polymer, at least one polymer resin and 5 to 25% by weight of mineral fillers and/or polymer fillers, in the form of particles of d50 size less than 25 μm;
Curing said culinary article in the oven at a temperature comprised between 400 and 450° C., for 1 to 15 min.

12. The method according to claim 12, wherein the decoration is applied by screen printing, by roller, by spray, by pad printing or by curtain.

13. The method according to claim 12, wherein the decoration is applied on the last primer layer or between two primer layers.

14. The culinary article according to claim 1, wherein the proportion of polymer resin(s) in the decoration layer is comprised between 1% and 1.5% by dry weight relative to the total weight of said decoration layer.
